(19) United States
(12) Patent Application Publication
(10) Pub. No.: US 2009/0319519 A1
(43) Pub. Date: Dec. 24, 2009

(54) COMMUNICATION SYSTEM, COMMUNICATION DEVICE, AND COMPUTER PROGRAM

(75) Inventors: Hironori Sakakihara, Kawasaki (JP); Naoki Nishiguchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/549,147

(22) Filed: Aug. 27, 2009

Related U.S. Application Data
(63) Continuation of application No. PCT/JP2007/057735, filed on Apr. 6, 2007.

(51) Int. Cl. G06F 17/30

(52) U.S. Cl. 707/5; 707/E17.109

(57) ABSTRACT

There is provided a communication system including a plurality of communication devices including first, second and third communication devices and performable of one-on-one communication with one another. The first communication device includes: a search request reception part receiving a search request for data from the second communication device; a determination part determining whether or not data relevant to the search request is retained; a search request transmission part transmitting, when the relevant data is not retained, the search request to the third communication device; a data reception part receiving the data relevant to the search request from the third communication device; a data transmission part transmitting, to the second communication device that has transmitted the search request, the data received by the data reception part. The first communication device relays the search request and the data from/to the second communication device and the third communication device.

This application is a continuation, filed under 35 U.S.C. §111(a), of PCT International Application No. PCT/JP2007/057735 which has an international filing date of Apr. 6, 2007, and designated the United States of America.

### FIELD

The embodiments discussed herein provide a communication system, a communication device and a computer program, which efficiently provide information to a user of each device through the use of a network such as a P2P (Peer to Peer) network configured so that search request, search response, search target data, etc., transmitted from one device are relayed by another device.

### BACKGROUND

Conventionally, various communication systems for providing information to users through the use of networks have been researched and developed, and put to practical use. For example, there has been proposed a digital video distribution system configured so that an edit server for creating a summarized video content of a video content to be distributed is provided, and the edit server creates the summarized video content on the basis of: viewing information for each viewer, concerning viewing of the video content; and video metadata associated with the video content. This digital video distribution system enables provision of a summarized video content regarded as being beneficial to a viewer, and enables realization of useful and various digital video distribution services (see Patent Document 1, for example).

Further, as a configuration of a network, a P2P (Pure P2P) network is coming into widespread use. In a P2P network, one of communication devices (hereinafter, referred to as “node”) constituting the network transmits a data search request to an adjacent node, sends a search response as a reply when the node that has received the search request retains the relevant data, and then transfers this data to a transmission source of the search request. Furthermore, when the node does not retain the relevant data, the search request is transmitted to a further adjacent node. In this manner, a plurality of nodes relay a search request, a search response and data, thereby enabling data search, transfer, and the like without the use of any special server device in a P2P network. Moreover, a P2P network has an advantage that a network configuration may be easily changed.

There has been proposed a peer-to-peer content delivery system capable of reducing the time required for a terminal device (content-requesting peer), which has requested a content, to acquire the content, thereby enabling a reduction in network traffic. In this system, when a content acquisition response signal is transferred from a content-possessing peer to a content-requesting peer, a cache device stores, in a cache storage, a content included in this content acquisition response signal, stores, in the cache storage, a content included in a content storage request signal sent from the content-possessing peer to the content-requesting peer, and stores, in the cache storage, a content stored in a public storage by the content-possessing peer. Thereafter, when the cache device has received a content acquisition request signal sent from the content-requesting peer to the content-possessing peer and the designated content has already been stored in the cache storage, the cache device returns the content acquisition response signal in place of the designated content-possessing peer (see Patent Document 2, for example).

There has been proposed an information search method capable of improving information search efficiency in a P2P network in which devices are connected in a tree structure. In this information search method, when one device has received an information disclosure request from a slave device, public information is stored, and the information disclosure request is transferred to a master device. Further, when an information search request has been received from the slave device, a search condition is stored, and the information search request is transferred to the master device. Thereafter, a search for stored public information is made on the basis of the stored search condition, and when the public information is hit by the search, the public information is transmitted to a transmission source of the information search request. In this manner, a search for all pieces of information open to the public within the network is enabled just by making a search for the public information stored in the device at a high position of the tree structure, resulting in an improvement in search efficiency (see Patent Document 3, for example).

There has been proposed a network system configured so that nodes, which constitute a P2P network with other nodes and mutually exchange a search request message and a response message for this message, are provided with a storage for storing, for a given period of time, a message relayed by the current node, and when the message corresponding to the search request received from the other node is stored in the storage, recommendation information indicating existence of a search result in this node is transmitted. This network system has an advantage that the other node easily finds out a target group, information or the like by the recommendation information (see Patent Document 4, for example).

### [Patent Document 1] Japanese Laid-Open Patent Publication No. 2005-136824

### [Patent Document 2] Japanese Laid-Open Patent Publication No. 2004-246786

### [Patent Document 3] Japanese Laid-Open Patent Publication No. 2005-159911

### [Patent Document 4] Japanese Laid-Open Patent Publication No. 2004-102531

### SUMMARY

A main object of all of the peer-to-peer content delivery system, the information search method and the network system is to increase the speed or efficiency of a search for data (content, message) in a P2P network. Hence, only the data relevant to the search performed personally by a user is exchanged between devices.

On the other hand, in the digital video distribution system, the edit server automatically edits, as a summarized video content, a video content regarded as being beneficial to a viewer, thus providing the content to a user. Hence, a user is allowed to know the existence of a beneficial video content without making a search, and to view this content, thus enabling provision of the digital video distribution system that offers significant advantages to a user. However, the system that recommends data, including such a beneficial video content, to a user is easily implementable in a client-server type network in which a server device for collectively managing data exists, but in a P2P network in which no server device exists, it is difficult to grasp all pieces of data possessed by respective nodes; consequently, it is not easy to implement the system that recommends beneficial data.

There is provided a communication system including a plurality of communication devices including first, second and third communication devices and performable of one-on-one communication with one another. The first communication device includes: a search request reception part receiving a search request for data from the second communication device; a determination part determining whether or not data relevant to the search request is retained; a search request transmission part transmitting, when the relevant data is not retained, the search request to the third communication device; a data reception part receiving the data relevant to the search request from the third communication device; a data transmission part transmitting, to the second communication device that has transmitted the search request, the data received by the data reception part. The first communication device relaying the search request and the data from/to the second communication device and the third communication device, further includes: a storage determination part determining whether or not the data received by the data reception part should be stored; a data storage storing the data determined to be stored by the storage determination part; a notification determination part determining whether or not information concerning the data stored in the data storage should be notified; and an information notification part providing notification of the information when the notification determination part has determined that the information should be notified, wherein the first communication device that has relayed the data relays the information from/to the second communication device and the third communication device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of a configuration of a communication system by means of a P2P network.

FIG. 2 is a block diagram illustrating an example of a hardware configuration of a node according to embodiments.

FIG. 3 is a block diagram illustrating an example of a functional configuration concerning communication of the node according to the embodiments.

FIG. 4 is a schematic diagram illustrating an example of a structure of a search request table.

FIG. 5 is a schematic diagram illustrating an example of a structure of a management table.

FIG. 6 is a schematic diagram illustrating an example of communication of the communication system according to Embodiment 1.

FIG. 7 is a schematic diagram illustrating an example of communication of the communication system according to Embodiment 1.

FIG. 8 is a schematic diagram illustrating an example of communication of the communication system according to Embodiment 1.

FIG. 9 is a schematic diagram illustrating an example of communication of the communication system according to Embodiment 1.

FIG. 10 is an operation chart illustrating a procedure of a process carried out by each node of the communication system according to the embodiment at the time of search request reception.

FIG. 11 is an operation chart illustrating a procedure of a process carried out by each node of the communication system according to the embodiment at the time of search response reception.

FIG. 12 is an operation chart illustrating a procedure of a recommendation go/no-go determination process carried out by each node of the communication system according to the embodiment.

FIG. 13 is an operation chart illustrating a procedure of a process carried out by each node of the communication system according to the embodiment at the time of transfer request reception.

FIG. 14 is an operation chart illustrating a procedure of a process carried out by each node of the communication system according to the embodiment at the time of content reception.

FIG. 15 is an operation chart illustrating a procedure of a content recommendation process carried out by each node of the communication system according to the embodiment.

FIG. 16 is an operation chart illustrating a procedure of a recommendation go/no-go determination process carried out by each node of a communication system according to Variant 1 of Embodiment 1.

FIG. 17 is a block diagram illustrating an example of a functional configuration concerning communication of a node according to Embodiment 2.

### DESCRIPTION OF EMBODIMENTS

### Embodiment 1

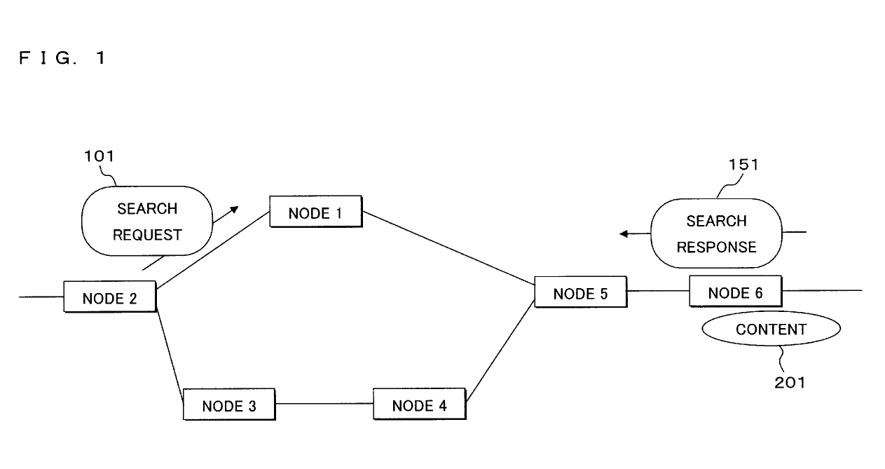

Hereinafter, one embodiment will be specifically described with reference to the drawings. FIG. 1 is a schematic diagram illustrating one configuration example of a communication system by means of a P2P network. The illustrated communication system includes six communication devices (hereinafter, referred to as “nodes”) 1 to 6. For example, the node 1 is allowed to perform one-on-one communication with the node 2 and the node 5. Similarly, the node 2 is allowed to perform communication with the node 1 and the node 3, the node 3 is allowed to perform communication with the node 2 and the node 4, and the node 4 is allowed to perform communication with the node 3 and the node 5. Furthermore, the node 5 is allowed to perform communication with the node 4 and the node 6, and the node 6 is allowed to perform communication with the node 5.

In the illustrated communication system, the description is made on the assumption that the node 6 retains data (hereinafter, referred to as a “content”) 201, and a user who utilizes the node 2 performs a search for the content 201. In this case, for example, the node 2 transmits a search request 101 for the content 201 to the node 1. The node 1 receives the search request 101, but transmits the search request 101 to the node 5 because the node 1 does not retain the content 201. Similarly, the node 5 also receives the search request 101 and transmits the request to the node 6. The node 6 that has received the search request 101 transmits, to the node 5, a search response 151 as a notification that the node 6 retains the content 201. The search response 151 is relayed via a path opposite to that of the search request 101, and received by the node 2.

Subsequently, the node 2 that has received the search response 151 transmits, to the node 6, a transfer request (illustration thereof is omitted) for the content 201. The transfer request transmitted from the node 2 is also relayed by the node 1 and the node 5, and received by the node 6. The node 6 that has received the transfer request transmits the content 201 to the node 2. The content 201 is relayed by the node 5 and the node 1, and received by the node 2. At this point in time, the node 1 and/or the node 5 are/is allowed to temporarily store the relayed content 201 as a cache content, and to transfer, upon reception of a similar search request, the cache content(s) stored by the node(s) without relaying the search request to the node 6, thereby enabling improvements in communication speed, communication response, etc.

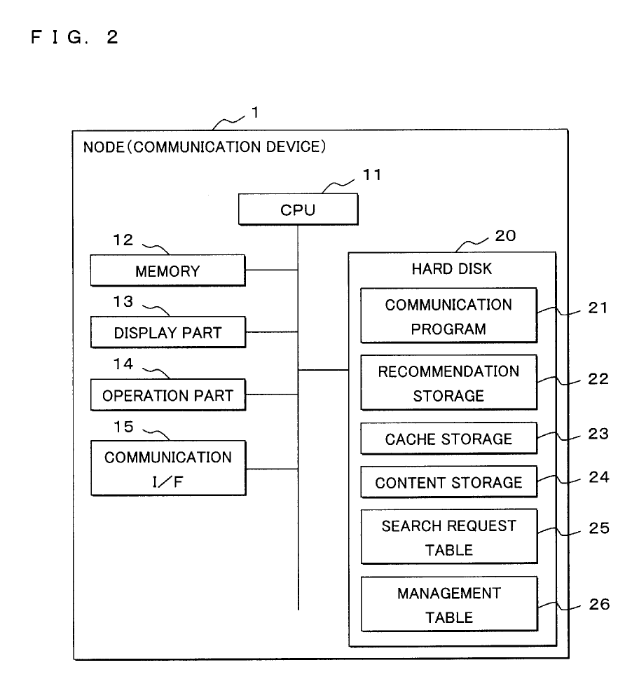

FIG. 2 is a block diagram illustrating a hardware configuration of the node 1 according to the embodiment. It should be noted that although the configuration of the node 1 is illustrated in FIG. 2, the configuration of each of the nodes 2 to 6 illustrated in FIG. 1 is approximately similar to that of the node 1, and therefore, the illustration thereof will be omitted. The node 1 includes: a CPU (Central Processing Unit) 11; a memory 12; a display part 13; an operation part 14; a communication I/F (interface) 15; and a hard disk 20. This is a configuration of a so-called “PC” (personal computer), and the communication system according to the embodiment may be configured by connecting, to a network, a plurality of general-purpose PCs as nodes.

The CPU 11 performs various arithmetic processes, control processes and the like of the respective parts of the node 1, and various computer programs stored on the hard disk 20 are read into the memory 12 and executed, thereby performing the arithmetic processes and control processes. The memory 12 includes mass storage memory elements accessible at a high speed such as DRAMs, and temporarily stores various pieces of data when the CPU 11 performs a process. The display part 13 includes a liquid crystal display, a CRT (Cathode Ray Tube) display or the like, and presents various characters, images or the like to a user. The operation part 14 includes a keyboard, a mouse and the like, and receives an operation performed by a user so as to notify the CPU 11 of operation details. The communication I/F 15 has a connection port through which a communication cable is connected, and receives/transmits data from/to another node via the communication cable. It is to be noted that the communication I/F may perform wireless communication.

The hard disk 20 is a large-capacity magnetic storage device of several hundred GB or more, and stores various programs to be executed by the CPU 11, data necessary for execution of these programs, etc. For example, the hard disk 20 stores programs (illustration thereof is omitted) such as applications including an OS (Operating System) and a word processor or spreadsheet. Further, in the hard disk 20 of the node 1 according to the embodiment, there are stored: a communication program 21 for performing P2P communication; and a search request table 25 and a management table 26 which are used when this communication program 21 performs a process, and in addition, the hard disk 20 is provided with: a content storage 24 for storing a content that may be provided to another node; a cache storage 23 for temporarily storing a relayed content as cache data; and a recommendation storage 22 for storing a content to be recommended to a user who utilizes the node 1.

In the communication system according to the embodiment, the respective nodes relay search request, search response, transfer request, content and the like as described above, thereby allowing two nodes, which do not directly perform communication therebetween, to indirectly exchange the content. Each node stores a content, which is to be open to another node, in the content storage 24. Furthermore, there is provided a function of enhancing the communication speed of the communication system by storing, as cache data, a relayed content in the cache storage 23 as described above, and in addition, there is provided a function of storing a relayed content in the recommendation storage 22, and displaying recommendation information for recommending this content on the display part 13, thereby notifying a user who utilizes each node about information concerning the content. These functions are realized by the communication program 21.

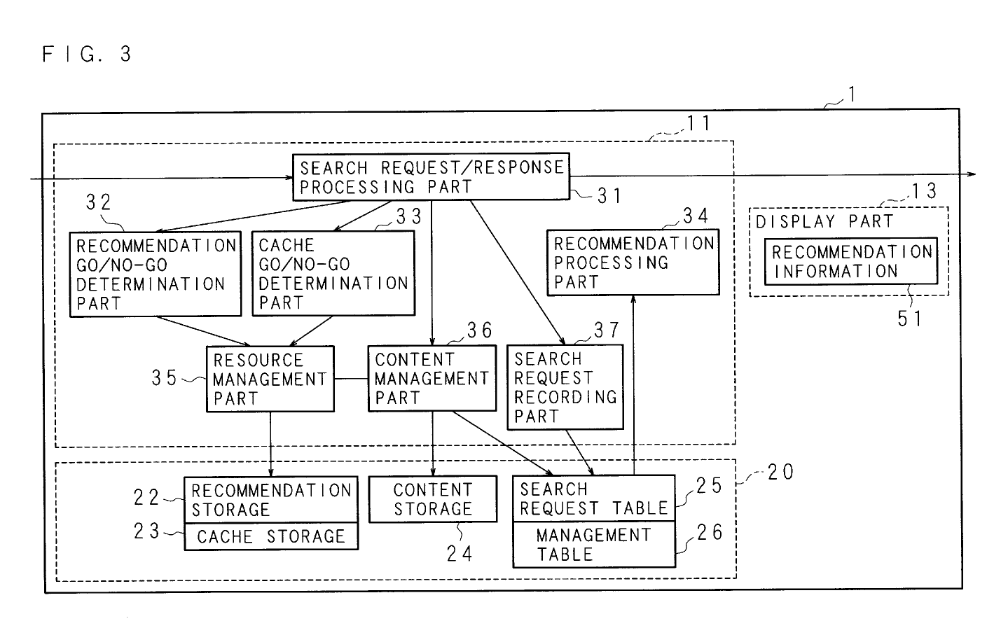

FIG. 3 is a block diagram illustrating a functional configuration concerning communication of the node 1 according to the embodiment, and the functional configuration is implemented by executing the communication program 21 by the CPU 11. It should be noted that the illustrated functional configuration is approximately similar to that of each of the nodes 2 to 6, and therefore, the illustration thereof will be omitted. Execution of the communication program 21 implements, in the CPU 11, functional blocks such as a search request/response processing part 31, a recommendation go/no-go determination part 32, a cache go/no-go determination part 33, a recommendation processing part 34, a resource management part 35, a content management part 36 and a search request recording part 37. The search request/response processing part 31 performs processes of receiving, via the communication I/F 15, a search request, a search response, a transfer request and a content transmitted from another node, supplying the received search request, search response, transfer request and content to the respective parts, and transmitting (relaying) the search request, search response, transfer request and content to another node in accordance with the received details.

When received a search request from another node, the search request/response processing part 31 supplies the search request to the content management part 36 and the resource management part 35, and checks whether or not a content relevant to the search request is stored in the content storage 24, the recommendation storage 22 or the cache storage 23. When the relevant content is stored in the content storage 24, the recommendation storage 22 or the cache storage 23, a search response is transmitted to the node that is the transmission source of the search request, and when the relevant content is not stored, the search request is transmitted to the node different from the transmission source. Further, the search request/response processing part 31 supplies the received search request to the search request recording part 37. In response to the supplied search request, the search request recording part 37 updates the search request table 25 and the management table 26 stored on the hard disk 20.

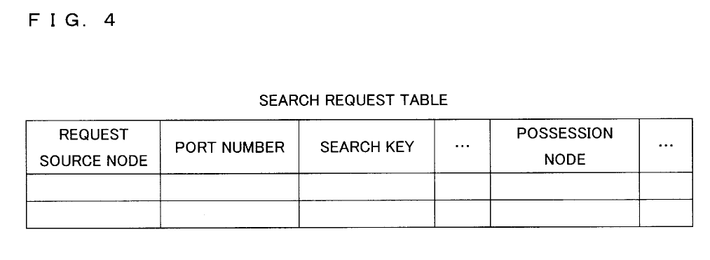

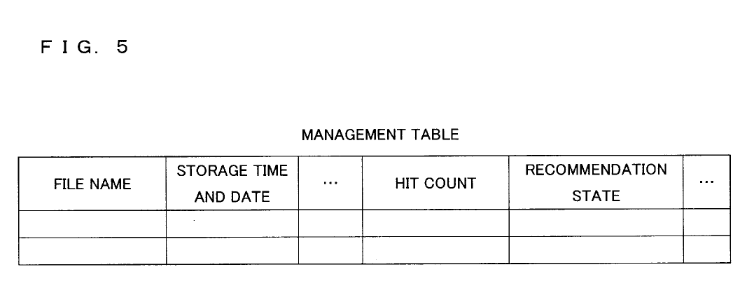

FIG. 4 is a schematic diagram illustrating one structural example of the search request table 25. Further, FIG. 5 is a schematic diagram illustrating one structural example of the management table 26. The search request table 25 is a table for storing information concerning a received search request, and stores information including a request source node of a search request, a port number, a search key inputted by a user, and a node possessing a content pertaining to the search request. Furthermore, the management table 26 is a table for managing a content stored in the recommendation storage 22, and stores information including a file name of a content, date and time at which the content is stored in the recommendation storage 22, a hit count indicating how many times a search request for this content is received after the storage thereof, and recommendation state indicating whether or not this content is recommended.

The search request table 25 is updated when a search request has been received from another node, and is also updated when a user has performed a search for a content in the current node and transmitted a search request to another node. The management table 26 is updated when a content is stored in the recommendation storage 22, when a search request has been received from another node, when a content is recommended, etc. It should be noted that items stored in the search request table 25 and the management table 26 may be provided so as to be deleted after a lapse of a given period of time, may be provided so as to be deleted from an older one when more than a given number of items are stored, and may be provided so as to be deleted by other methods.

It should be noted that when a content relevant to a search request received from another node is stored in the recommendation storage 22, the search request/response processing part 31 transmits a search response to the transmission source node of the search request as described above, and updates the management table 26 to increment the hit count of the relevant content. Further, the search response transmitted by the search request/response processing part 31 includes information pertaining to the node possessing the relevant content, and information pertaining to this content (e.g., information such as a file name, a file size, a content author, a provider, a created date and time or a summary).

Furthermore, when a search response has been received from another node, the search request/response processing part 31 supplies the search response to the search request recording part 37, and stores information, concerning the node possessing the content pertaining to the search request, in the relevant item of the search request table 25 on the basis of the search response. Moreover, the search request/response processing part 31 checks whether or not this search response is provided in response to the search request of the current node, and when the search response is provided in response to the search request of the current node, the search request/response processing part 31 then transmits a content transfer request to the node that has transmitted the search response.

When the received search response is not provided in response to the search request of the current node, i.e., when the received search response is provided in response to a relayed search request, the search request/response processing part 31 supplies the received search response to the recommendation go/no-go determination part 32, and it is determined whether or not the content pertaining to the search response should be stored, as a content to be recommended to a user, in the recommendation storage 22.

The recommendation go/no-go determination part 32 determines whether or not a content should be stored in the recommendation storage 22 on the basis of the search request table 25 stored on the hard disk 20, and first checks the request source node in the search request table 25, thereby acquiring information pertaining to a search request issued from the current node. Subsequently, on the basis of a search key included in the information pertaining to the search request issued from the current node, it is checked whether or not there is similarity between the content for which a search is performed by this search key, and the content pertaining to a received search response. The recommendation go/no-go determination part 32 determines that the content pertaining to the received search response should be stored in the recommendation storage 22 when there is similarity between the contents, and determines that the received content should not be stored in the recommendation storage 22 when there is no similarity between the contents.

The existence or nonexistence of similarity may be determined on the basis of whether or not the keyword of a search key, for example, is identical to or similar to the keyword of information included in a content, whether or not the keyword of a search key is identical to or similar to the file name of a content, etc. Therefore, each node possessing a content transmits information for similarity determination in a manner included in a search response. Further, a keyword group having similarity may be stored in advance as a dictionary file, and reference may be made to this dictionary file when a determination is made. It is to be noted that determination methods are not limited to those described above, but other methods may be used.

When it is determined in the recommendation go/no-go determination part 32 that the content pertaining to the search response should be stored for recommendation, the search request/response processing part 31 changes information of the content-possessing node included in the received search response to define the possessing node as the current node, and then transmits the changed search response to the transmission source node of the search request. When it is determined in the recommendation go/no-go determination part 32 that the content pertaining to the search response should not be stored for recommendation, the search request/response processing part 31 transmits the received search response to the transmission source node of the search request without making any change to the search response.

Further, when the search request/response processing part 31 has received a transfer request from another node, first, it is checked whether or not this transfer request is the one provided for the current node. When the received transfer request is not the one provided for the current node, the transfer request is transmitted to the content-possessing node. When the transfer request is the one provided for the current node, there exist a case where the current node retains the requested content, and a case where information of the possessing node included in the search response is changed and transmitted as described above.

In the case where the current node retains the content, the content pertaining to the transfer request is read from the content storage 24, the recommendation storage 22 or the cache storage 23, and is transmitted to the transmission source node of the transfer request. In the case where the search response is changed and transmitted, the current node does not retain this content; therefore, reference is made to the search request table 25 to check the content-possessing node, and the content transfer request is transmitted to this node. Thereafter, the search request/response processing part 31 receives the content, stores the content in the recommendation storage 22, and transmits this content to the transmission source node of the transfer request.

Furthermore, when the search request/response processing part 31 has received the content from another node, it is checked whether or not this content is the one provided in response to the transfer request of the current node. When the received content is the one provided in response to the transfer request of the current node, the content management part 36 stores this content in the content storage 24, or the resource management part 35 stores the content in the recommendation storage 22 as described above.

When the content is not the one provided in response to the transfer request of the current node, this content is transmitted to another node. It is to be noted that when the received content is transmitted to another node, the search request/response processing part 31 supplies the received content to the cache go/no-go determination part 33, and it is determined whether or not this content should be stored in the cache storage 23. The storing of a content as cache data by the cache storage 23 is carried out in order to increase the communication speed of the communication system implemented by means of a P2P network. The cache go/no-go determination part 33 determines whether or not content caching should be performed in accordance with a rule determined in advance in the communication system. For example, this may be determined in accordance with the number of nodes (i.e., the so-called “number of hops”) by which a received content is relayed (e.g., the content is stored when the number of hops is an even number), but may be determined in accordance with another rule. These determination methods are performed by already-existing techniques, and therefore, the detailed description thereof will be omitted in the embodiment.

Furthermore, the content, stored in the recommendation storage 22 as a result of the determination made by the recommendation go/no-go determination part 32, is subjected to a determination as to whether or not the content should be recommended by the recommendation processing part 34, and then recommendation information 51 is displayed on the display part 13, thereby performing a recommendation process for a user. First, the recommendation processing part 34 reads the management table 26 stored on the hard disk 20, checks the hit count of each of unrecommended contents, and determines, as a content to be recommended, the content whose hit count is greater than a threshold value set in advance. Subsequently, the recommendation information 51 is created for the content determined to be recommended, and the recommendation information 51 is displayed on the display part 13.

The recommendation information 51 created at this point is formed by character, image or the like including a content file name and content-related simple information, for example. The recommendation processing part 34 displays, as an icon, the recommendation information 51 formed by character, image or the like in a corner of a display screen of the display part 13, for example, or displays the recommendation information 51 by a method such as a pop-up menu display. Further, the recommendation information may be not only displayed on the display part 13, but also formed so as to be outputted as an audio output.

Thus, when a content is relayed, the content is stored in the recommendation storage 22 by making a determination in the recommendation go/no-go determination part 32 on the basis of the search request table 25, and the stored content is displayed as the recommendation information 51 on the display part 13 by making a determination in the recommendation processing part 34 on the basis of the management table 26, thereby enabling selection and recommendation of data beneficial to the user of the current node from among contents for which searches are made by other nodes.

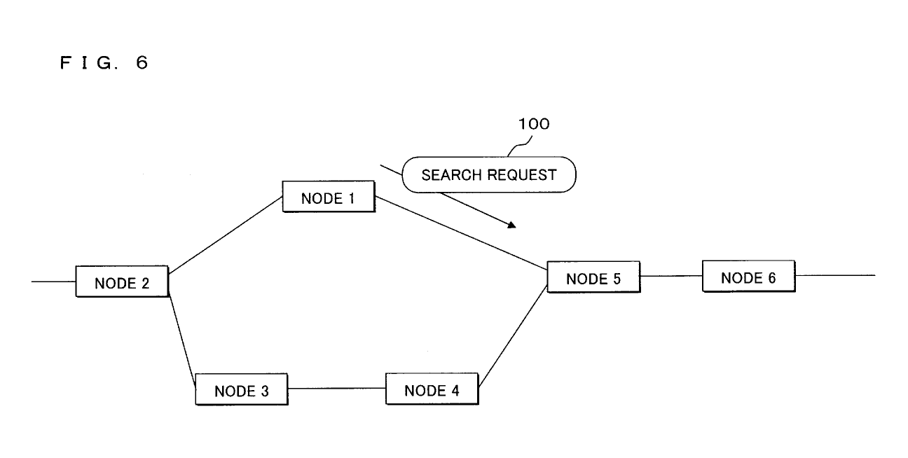

FIGS. 6 to 9 are schematic diagrams each illustrating an example of communication of the communication system according to Embodiment 1. For example, the description is made on the assumption that in the communication system illustrated in FIG. 1, first, the node 1 has issued a search request 100 for a content, which the nodes 1 to 6 do not retain (see FIG. 6). The other nodes 2 to 6 will not transmit a search response in response to this request. When transmitting the search request 100, the node 1 updates the search request table 25 to add information concerning the search request 100.

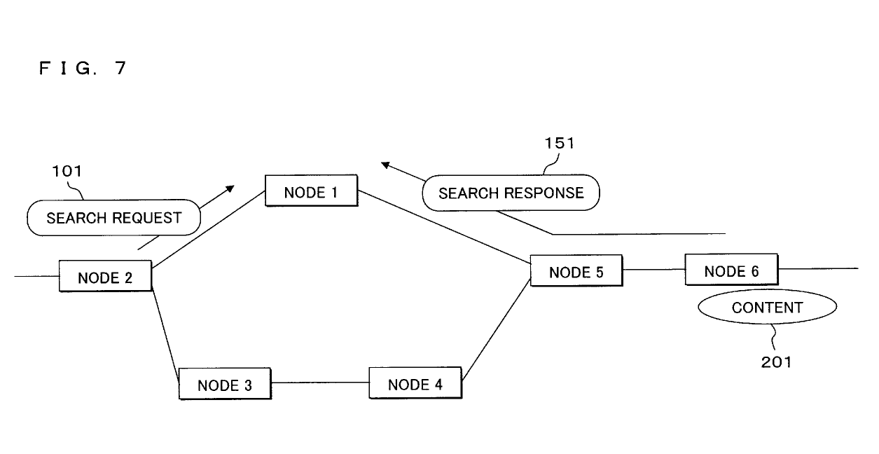

Then, the description is made on the assumption that the node 2 transmits the search request 101 for the content 201 to the node 1, and the node 6 retains the content 201. The node 1 that has received the search request 101 checks whether or not it retains the content 201, and transmits the search request 101 to the node 5 since the node 1 does not retain the content 201. At this point in time, the node 1 updates the search request table 25 to add information concerning the search request 101. The node 5 similarly transmits the search request 101 to the node 6. Since the node 6 retains the content 201, the node 6 transmits the search response 151 to the node 5, and the node 5 that has received this response transmits the search response 151 to the node 1 (see FIG. 7).

The node 1 that has received the search response 151 updates the search request table 25 to store information concerning the content-possessing node. Further, since the received search response 151 is not the one provided in response to the search request issued by the current node (node 1), the search response 151 is supplied to the recommendation go/no-go determination part 32, and it is determined whether or not the content 201 pertaining to the search response 151 should be stored in the recommendation storage 22 as a content to be recommended to a user.

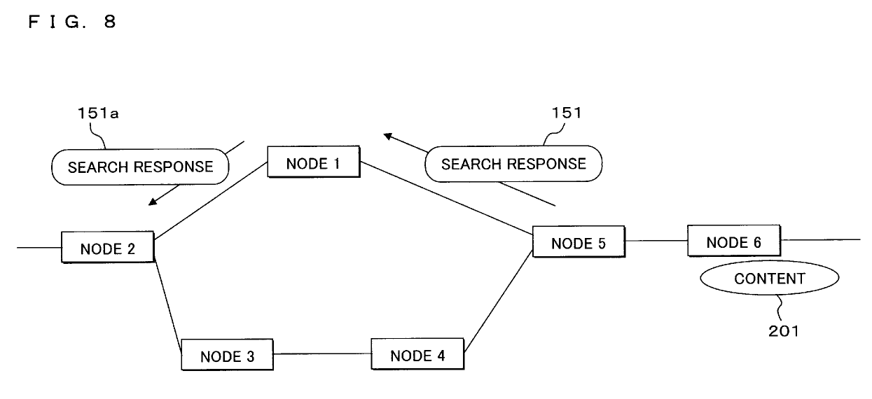

In this case, the description is made on the assumption that there is similarity between the content for which a search is made by the search request 100, and the content 201 pertaining to the search response 151. Since the recommendation go/no-go determination part 32 determines that the content 201 pertaining to the search response 151 should be stored, the search request/response processing part 31 changes the content-possessing node, which is information included in the search response 151, to the current node to provide a search response 151a, and transmits the search response 151a from the node 1 to the node 2 (see FIG. 8).

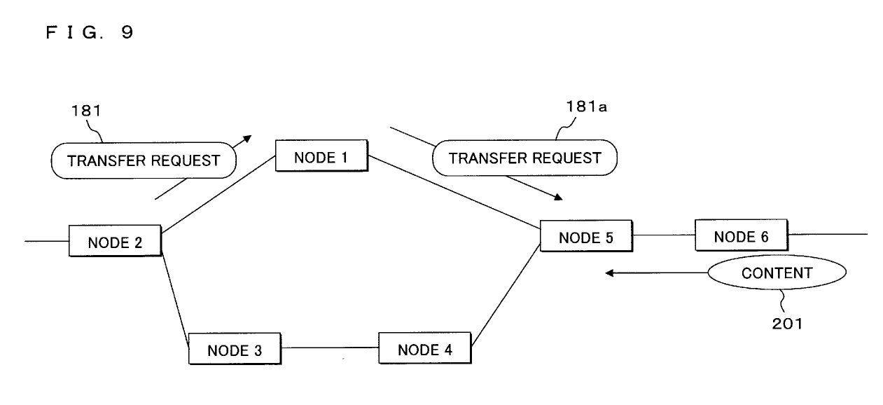

The node 2 that has received the search response 151a determines that the node 1 is the node possessing the content 201, and transmits a transfer request 181 for the content 201 to the node 1. Since the node 1 that has received the transfer request 181 does not retain the content 201, the node 1 makes reference to the search request table to examine that the node retaining the content 201 is the node 6, and transmits a transfer request 181a for the content 201 to the node 6. The transfer request 181a is relayed by the node 5, and received by the node 6. The node 6 that has received the transfer request 181a transmits the content 201 to the node 1, and the content 201 is relayed by the node 5 and received by the node 1 (see FIG. 9).

The node 1 that has received the content 201 stores the content 201 in the recommendation storage 22, and transmits the content 201 to the node 2. Thus, the node 2 is allowed to acquire the desired content 201. Furthermore, in the node 1, the content 201 is stored in the recommendation storage 22 so as to be put in a recommendable state, and when the hit count of a search request for the content 201 from another node has exceeded a threshold value, the recommendation processing part 34 displays the recommendation information 51 pertaining to the content 201 on the display part 13, thereby recommending the content 201.

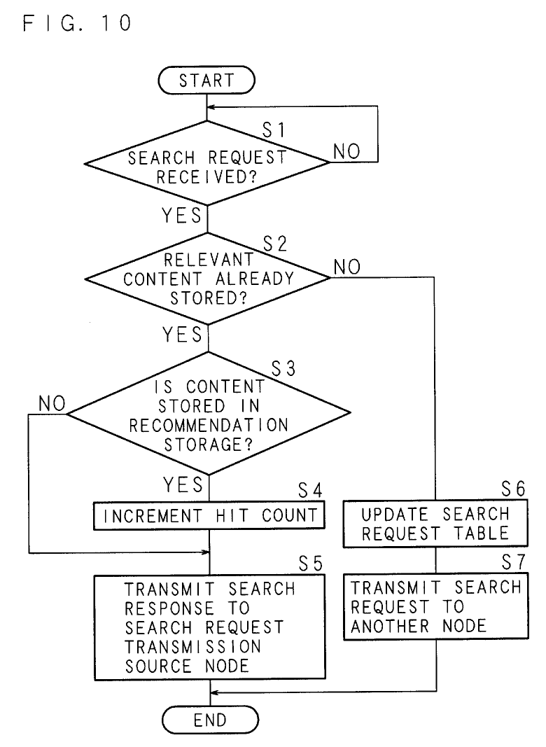

Next, a process carried out by each node of the communication system according to the embodiment will be described with reference to an operation chart. FIG. 10 is an operation chart illustrating a procedure of a process carried out by each node of the communication system according to the embodiment at the time of search request reception. The search request/response processing part 31 of the node first checks whether or not a search request has been received from another node (at Step S1), and when no search request has been received (when the answer is NO in Step S1), the search request/response processing part 31 is put on standby until a search request is received. When a search request has been received (when the answer is YES in Step S1), it is checked whether or not a content relevant to the received search request has already been stored in any of the content storage 24, the recommendation storage 22 and the cache storage 23 (at Step S2).

When the content relevant to the search request has already been stored (when the answer is YES in Step S2), it is further checked whether or not this content is stored in the recommendation storage 22 (at Step S3). When this content is stored in the recommendation storage 22 (when the answer is YES in Step S3), the hit count of the relevant content in the management table 26 is incremented (at Step S4). When this content is not stored in the recommendation storage 22 (when the answer is NO in Step S3) or after the hit count has been incremented in Step S4, a search response, serving as a notification that this content is retained, is transmitted to a search request transmission source node (at Step S5), thus ending the process.

Further, when it is checked in Step S2 that the content relevant to the received search request is not stored (when the answer is NO in Step S2), the received search request is supplied to the search request recording part 37 to update the search request table 25 (at Step S6), thereby adding information pertaining to the received search request to the search request table 25. Subsequently, this search request is transmitted to another node different from the transmission source (at Step S7), thus ending the process.

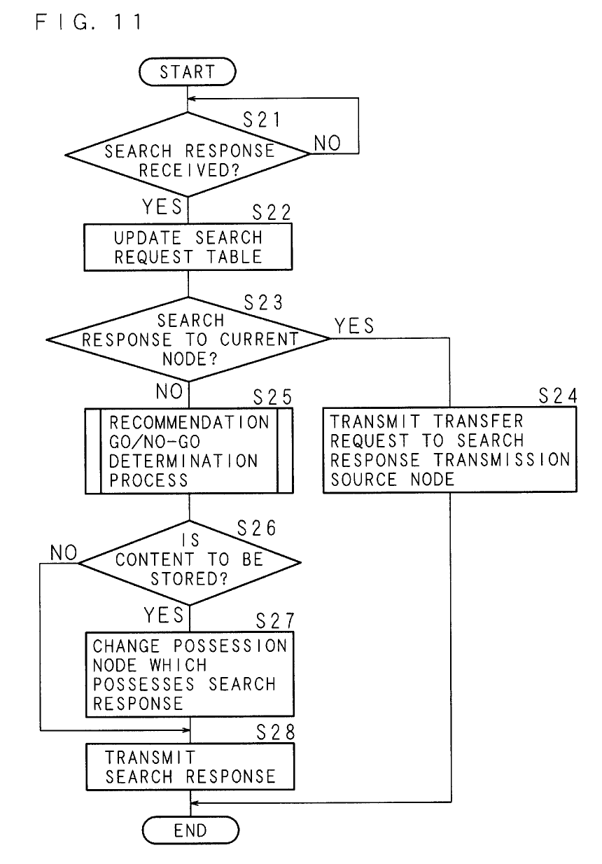

FIG. 11 is an operation chart illustrating a procedure of a process carried out by each node of the communication system according to the embodiment at the time of search response reception. The search request/response processing part 31 first checks whether or not a search response has been received from another node (at Step S21), and when no search response has been received (when the answer is NO in Step S21), the search request/response processing part 31 is put on standby until a search response is received. When a search response has been received (when the answer is YES in Step S21), the search request table 25 is updated (at Step S22) to add information pertaining to the search request corresponding to the received search response.

Subsequently, it is checked whether or not the received search response is the one provided for the current node (at Step S23), and when the search response is the one provided for the current node (when the answer is YES in Step S23), a content transfer request is transmitted to a search response transmission source node (at Step S24), thus ending the process. When the received search response is not the one provided for the current node (when the answer is NO in Step S23), a recommendation go/no-go determination process is performed to determine whether or not a content pertaining to this search response should be stored as a recommended content in the recommendation storage 22 (at Step S25).

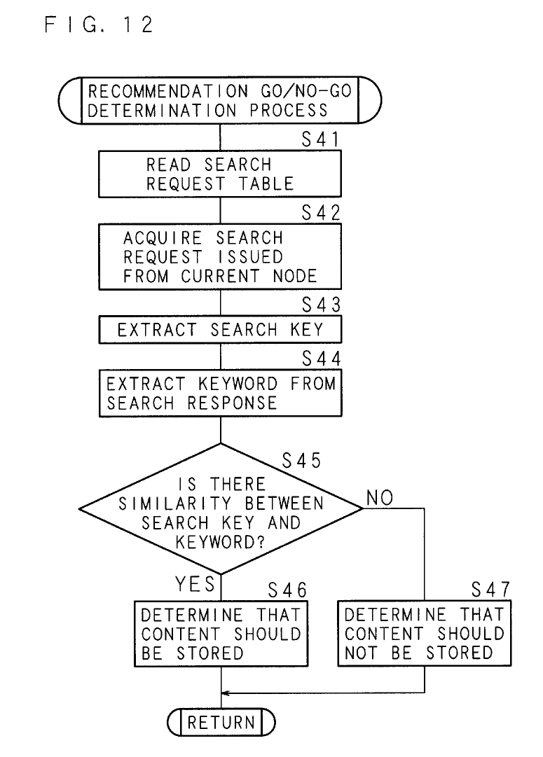

FIG. 12 is an operation chart illustrating a procedure of the recommendation go/no-go determination process carried out by each node of the communication system according to the embodiment. Further, the illustrated process is a process carried out in Step S25 of FIG. 11 by the recommendation go/no-go determination part 32. The recommendation go/no-go determination part 32 first reads the search request table 25 (at Step S41) to check items of a request source node in the search request table 25, thereby acquiring the search request issued from the current node (at Step S42). Subsequently, a search key is extracted from the acquired search request (at Step S43).

Then, a keyword is extracted from information included in the search response received by the search request/response processing part 31 (at Step S44), and it is checked whether or not there is similarity between the search key extracted in Step S43 and the keyword extracted in Step S44 (at Step S45). When there is the similarity (when the answer is YES in Step S45), it is determined that the content pertaining to this search response should be stored in the recommendation storage 22 (at Step S46), and when there is no similarity (when the answer is NO in Step S45), it is determined that the content should not be stored (at Step S47), thus ending the recommendation go/no-go determination process.

After the recommendation go/no-go determination process has ended, it is checked whether or not the content is determined to be stored in the recommendation storage 22 as a result of the determination (at Step S26). When the content has been determined to be stored (when the answer is YES in Step S26), information of the possessing node included in the received search response is changed to that of the current node (at Step S27). When the content has not been determined to be stored (when the answer is NO in Step S26) or after a change has been made to the search response in Step S27, the received search response or the changed search response is transmitted to another node (at Step S28), thus ending the process.

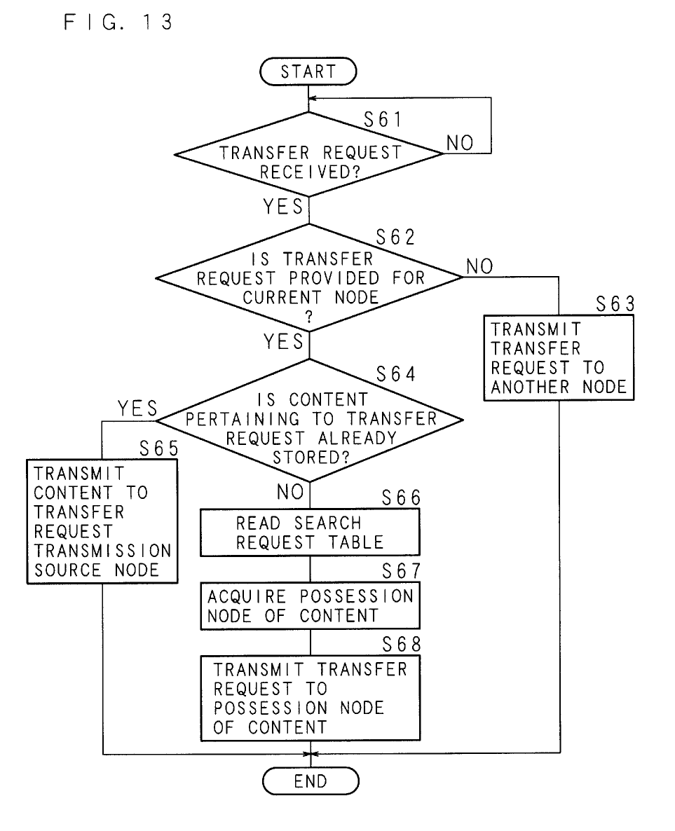

FIG. 13 is an operation chart illustrating a procedure of a process carried out by each node of the communication system according to the embodiment at the time of transfer request reception. The search request/response processing part 31 first checks whether or not a content transfer request has been received from another node (at Step S61), and when no transfer request has been received (when the answer is NO in Step S61), the search request/response processing part 31 is put on standby until a transfer request is received. When a transfer request has been received (when the answer is YES in Step S61), it is further checked whether or not this transfer request is the one provided for the current node (at Step S62). When this transfer request is not the one provided for the current node (when the answer is NO in Step S62), this transfer request is transmitted to another node (at Step S63), thus ending the process.

When the received transfer request is the one provided for the current node (when the answer is YES in Step S62), it is further checked whether or not the content pertaining to this transfer request is the content that has already been stored in the content storage 24, the recommendation storage 22 or the cache storage 23 (at Step S64). When the relevant content has already been stored in any one of these storages (when the answer is YES in Step S64), this content is read and transmitted to the transfer request transmission source node (at Step S65), thus ending the process.

When the content pertaining to the transfer request is not the content that has already been stored (when the answer is NO in Step S64), the search request table 25 is read (at Step S66), and the node possessing the content pertaining to this transfer request is acquired from the search request table 25 (at Step S67). Subsequently, the transfer request for this content is transmitted to the acquired possessing node (at Step S68), thus ending the process.

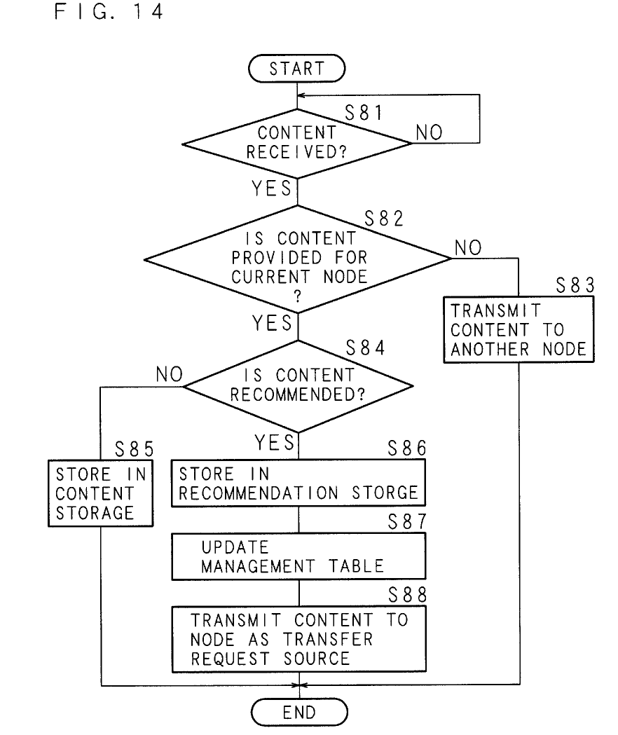

FIG. 14 is an operation chart illustrating a procedure of a process carried out by each node of the communication system according to the embodiment at the time of content reception. The search request/response processing part 31 first checks whether or not a content has been received from another node (at Step S81), and when no content has been received (when the answer is NO in Step S81), the search request/response processing part 31 is put on standby until a content is received. When a content has been received (when the answer is YES in Step S81), it is checked whether or not this content is the content provided for the current node (i.e., whether or not this content is the content transmitted in response to the transfer request issued from the current node (at Step S82)). When this content is not the one provided for the current node (when the answer is NO in Step S82), the received content is transmitted to another node (at Step S83), thus ending the process. It is to be noted that although illustration is omitted, prior to the transmission of the received content to another node, a process for determining whether or not this content should be stored in the cache storage 23, and a process for storing the content in accordance with the determination result are carried out.

When the received content is the content provided for the current node (when the answer is YES in Step S82), it is further checked whether or not this content is a recommended content (i.e., whether or not this content is a content provided in response to the transfer request transmitted in Step S68 of FIG. 13 (at Step S84)). When this content is not a recommended content (when the answer is NO in Step S84), this content is the content relevant to the search request issued from the current node (i.e., the content provided in response to the transfer request transmitted in Step S24 of FIG. 11); therefore, this content is stored in the content storage 24 (at Step S85), thus ending the process.

When the received content is a recommended content (when the answer is YES in Step S84), this content is stored in the recommendation storage 22 (at Step S86), and the management table 26 is updated (at Step S87) to add information pertaining to this content. In this case, the received content is the content obtained by the issue of the search request from another node and the transmission of the transfer request to the current node, and therefore, the received content is transmitted to the node serving as the transfer request source of this content (at Step S88), thus ending the process.

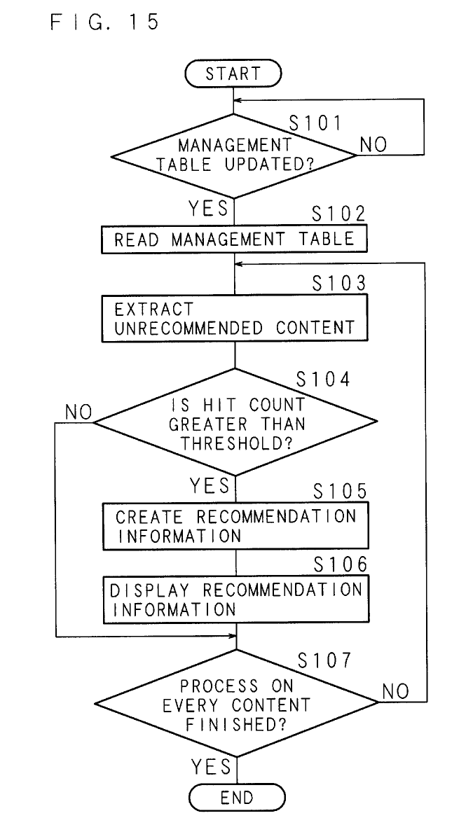

FIG. 15 is an operation chart illustrating a procedure of a content recommendation process carried out by each node of the communication system according to the embodiment, in which the process is performed by the recommendation processing part 34. The recommendation processing part 34 first checks whether or not the management table 26 has been updated (at Step S101), and when the table has not been updated (when the answer is NO in Step S101), the recommendation processing part 34 is put on standby until the table is updated. When the management table 26 has been updated (when the answer is YES in Step S101), this management table 26 is read (at Step S102).

Subsequently, one of unrecommended contents is extracted from the read management table 26 (at Step S103), and it is checked whether or not the hit count of this content is greater than a threshold value (at Step S104). When the hit count is greater than the threshold value (when the answer is YES in Step S104), the recommendation information 51 pertaining to this content is created (at Step S105), and the created recommendation information 51 is displayed on the display part 13 (at Step S106). When the hit count is not greater than the threshold value (when the answer is NO in Step S104) or after the recommendation information 51 has been displayed in Step S106, it is checked whether or not the process steps of Steps S103 to S106 have been finished on all the unrecommended contents included in the management table 26 (at Step S107). When the process steps have not been finished on all the contents (when the answer is NO in Step S107), the process returns to Step S103 to extract the next unrecommended content, and the above-described process steps are repeatedly performed. When the process steps have been finished on all the contents (when the answer is YES in Step S107), the recommendation process ends.

In the communication system according to Embodiment 1 configured as described above, when a search response to another node is relayed, it is determined whether or not a content pertaining to this search response should be stored so as to be recommended, and when a content to another node is relayed, this content is stored in the recommendation storage 22 in accordance with the determination result, thereby allowing the content, for which a search is made by a user who utilizes another node, to be stored so as to be recommended to a user who utilizes the current node. At this point, on the basis of a search key or the like by which the user of the current node has previously performed a search, similarity between contents is checked, and the content having similarity is stored in advance, thereby enabling recommendation of a more beneficial content to the user. Moreover, the embodiment is implemented so that in accordance with the hit count of a search request for the content stored in the recommendation storage 22, this content is recommended, thereby allowing more contents, which are requested by other users and popular, to be recommended to the user who utilizes the current node.

It should be noted that Embodiment 1 is implemented so that the content storage 24, the recommendation storage 22 and the cache storage 23 are provided in the single hard disk 20, but the embodiment is not limited to this; alternatively, the embodiment may be implemented so that these storages are provided in different hard disks. Further, the storage capacity of each storage may be fixed, or may be variable. Furthermore, the embodiment is implemented so that a content is recommended only when the hit count thereof exceeds a threshold value after the content has been stored in the recommendation storage 22, but the embodiment is not limited to this; alternatively, the embodiment may be implemented so that a content is recommended unconditionally (i.e., on the condition that the threshold value of the hit count is zero) immediately after the content has been stored in the recommendation storage 22. Optionally, the embodiment may be implemented by the following variants.

### Variant 1 of Embodiment 1

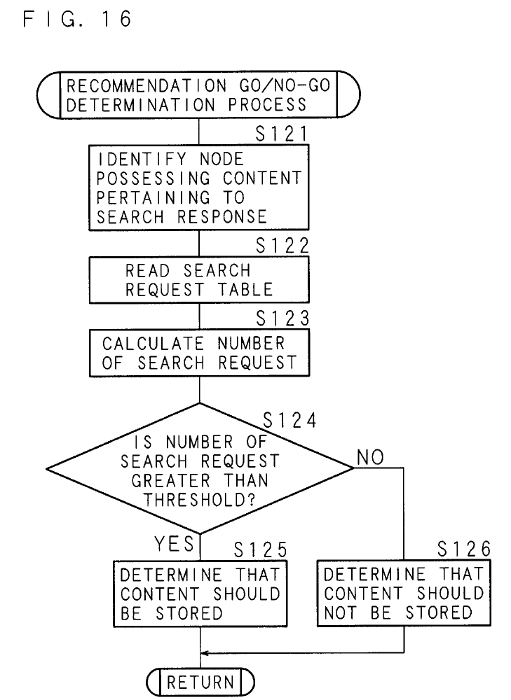

In Embodiment 1, as illustrated in FIG. 12, the determination of the recommendation go/no-go determination part 32 is performed on the basis of a search request previously issued from the current node, but the embodiment is not limited to this; alternatively, for example, the following method may be used, or still another method may be used. FIG. 16 is an operation chart illustrating a procedure of a recommendation go/no-go determination process carried out by each node of a communication system according to Variant 1 of Embodiment 1, in which the process is performed in Step S25 of FIG. 11.

The recommendation go/no-go determination part 32 first checks a search response received by the search request/response processing part 31 to identify a node possessing a content pertaining to the search response (at Step S121). Subsequently, the search request table 25 is read (at Step S122) to check the possessing node in the search request table 25, thereby calculating the number of search requests for the possessing node identified in Step S121 (at Step S123), and checking whether or not the number of the search requests is greater than a threshold value (at Step S124). When the number of the search requests is greater than the threshold value (when the answer is YES in Step S124), it is determined that the content pertaining to this search response should be stored in the recommendation storage 22 (at Step S125), and when the number of the search requests is not greater than the threshold value (when the answer is NO in Step S124), it is determined that the content should not be stored (at Step S126), thus ending the recommendation go/no-go determination process.

As described above, information pertaining to a relayed search request is stored in the search request table 25, and the number of the search requests issued is calculated for a node possessing a content pertaining to a search response, thereby enabling estimation of popularity of this possessing node from another node. Hence, when the number of the search requests calculated is greater than a threshold value, this possessing node has a high probability of possessing the popular content, and therefore, it is determined that the content pertaining to this possessing node should be stored as a recommended content in the recommendation storage 22. Thus, the popular content may be recommended to the user who utilizes the current node.

### Variant 2 of Embodiment 1

In Embodiment 1, only a content stored in the recommendation storage 22 is defined as an object to be recommended by the recommendation processing part 34, but the embodiment is not limited to this; alternatively, a content stored in the cache storage 23 may also be defined as an object to be recommended. For this purpose, in addition to information of a content stored in the recommendation storage 22, information of a content stored in the cache storage 23 is stored in the management table 26, and upon reception of a search request from another node, the hit count in the management table 26 is incremented. For the content whose hit count in the management table 26 is greater than a threshold value, the recommendation processing part 34 creates the recommendation information 51 and displays the recommendation information on the display part 13 irrespective of whether this content is the content stored in the recommendation storage 22 or the content stored in the cache storage 23.

It should be noted that when both of the content stored in the recommendation storage 22 and the content stored in the cache storage 23 are defined as objects to be recommended, the recommendation storage 22 and the cache storage 23 may be provided as the single common storage instead of providing them as different storages.

### Embodiment 2

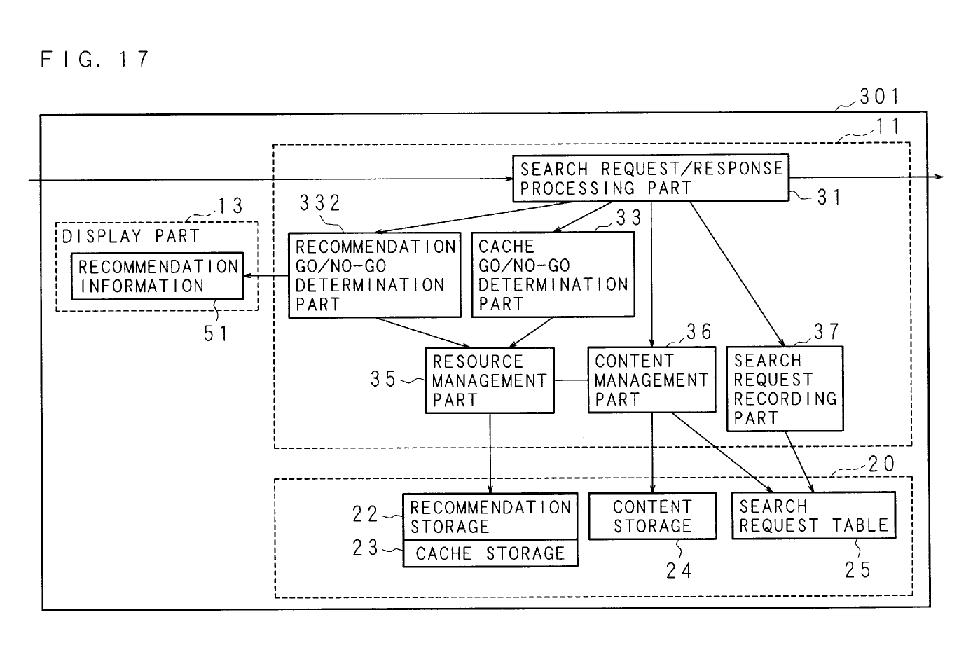

In the communication system according to Embodiment 1, when relaying a content, each node stores this content in the recommendation storage 22, and then the recommendation processing part 34 recommends this content from the recommendation storage 22. On the other hand, a communication system according to Embodiment 2 is configured so that before relaying a content or more specifically when relaying a search response, each node recommends the content. FIG. 17 is a block diagram illustrating a functional configuration concerning communication of a node 301 according to Embodiment 2. The configuration of the node 301 according to Embodiment 2 is approximately similar to that of the node 1 according to Embodiment 1 illustrated in FIG. 3, but the node 301 is configured so that the recommendation processing part 34 and the management table 26 provided in the node 1 are not provided, and a recommendation go/no-go determination part 332 creates and displays the recommendation information 51 in accordance with a determination result.

Using a method similar to that of the recommendation go/no-go determination part 32 of the node 1 according to Embodiment 1, the recommendation go/no-go determination part 332 determines whether or not a content pertaining to a search response should be stored in the recommendation storage 22. At this point, when the content pertaining to the search response is determined to be stored, the recommendation information 51 pertaining to this content is created, and is displayed on the display part 13. It should be noted that the determination method may be the method illustrated in FIG. 12, may be the method illustrated in FIG. 16, or may be any other method.

In the embodiment, each communication device of a network is configured so as to relay a search request from one communication device to another communication device, and so as to relay, to the one communication device, data transmitted from another communication device and relevant to the search. At this point, the communication device, which relays the data, stores this data by determining whether or not this data should be stored as data to be recommended, determines whether or not information concerning the stored data should be notified, and provides notification of the information to a user who utilizes this communication device. Thus, beneficial data may be recommended to the user from among pieces of data temporarily stored for relaying.

Information pertaining to a search request issued from the communication device itself is stored so that whether or not the relayed data should be stored may be determined on the basis of this information. For example, it may be determined whether or not the relayed data is similar to data for which a search is requested, and the relayed data may be stored when it is the similar data. Data for which a search is requested by a user is beneficial data, and data similar to this data has a high probability of being beneficial data.

Further, whether or not the relayed data should be stored may be determined on the basis of information pertaining to another communication device retaining data relevant to a search request issued from the current device or another device. For example, which communication device retains the data is stored each time relaying is performed, thereby enabling checking of the communication device to which access is frequently made. The communication device to which access is frequently made has a high probability of retaining beneficial data; therefore, when the data transmitted from this communication device is relayed, this data may be stored as recommended data.

In the communication system of the embodiment, when a search request from another communication device has been received for data stored at the time of relaying of each communication device, the stored data is transmitted as a search result without transferring of the search request. Whether or not information concerning data stored at the time of relaying should be notified is determined on the basis of calculation of the frequency of the search request from another communication device for the stored data, i.e., on the basis of whether or not this frequency is greater than a threshold value. The data, for which the frequency of the search request from another communication device is high, has a high probability of being beneficial data.

Moreover, in the communication system of the embodiment, when each communication device relays data, a search request from one communication device is relayed to another communication device, a search response from another communication device retaining data relevant to the search request is relayed to the one communication device, and then the data from another communication device is relayed to the one communication device. When relaying a search response, each communication device is allowed to find out another communication device retaining data pertaining to a search request. Therefore, when a search response has been received, it is determined whether or not information concerning data pertaining to the search response should be notified, thereby providing notification of the information. Thus, a recommendation may be made before data is relayed.

In the embodiments, even in the case of a communication system such as a P2P network having no server device, beneficial data is recommendable to a user, who utilizes each communication device, in accordance with a search history of this user or the frequency of access by the other user, etc. Hence, a user is allowed to have an opportunity to acquire a larger number of pieces of beneficial data, and an improvement in convenience of the communication system is enabled.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A communication system comprising a plurality of communication devices including first, second and third communication devices and performable of one-on-one communication with one another, the first communication device including:
a search request reception part receiving a search request for data from the second communication device;
a determination part determining whether or not data relevant to the search request is retained;
a search request transmission part transmitting, when the relevant data is not retained, the search request to the third communication device;
a data reception part receiving the data relevant to the search request from the third communication device;
a data transmission part transmitting, to the second communication device that has transmitted the search request, the data received by the data reception part, the first communication device relaying the search request and the data from/to the second communication device and the third communication device;
a storage determination part determining whether or not the data received by the data reception part should be stored;
a data storage storing the data determined to be stored by the storage determination part;
a notification determination part determining whether or not information concerning the data stored in the data storage should be notified; and
an information notification part providing notification of the information when the notification determination part has determined that the information should be notified,
wherein the first communication device that has relayed the data relays the information from/to the second communication device and the third communication device.

2. The communication system according to claim 1,
wherein the first communication device has a search request information storage storing information pertaining to a search request transmitted from the first communication device itself, and
wherein the storage determination part makes determination on the basis of the information stored in the search request information storage.

3. The communication system according to claim 1,
wherein the first communication device has a search request information storage storing information pertaining to another first communication device that retains data relevant to the search request received by the search request reception part, and
wherein the storage determination part makes determination on the basis of the information stored in the search request information storage.

4. The communication system according to claim 1,
wherein the notification determination part determines that information concerning the data stored in the data storage should be notified when the frequency of the search request for the data stored in the data storage has exceeded a threshold value, the search request being received from the second communication device.

5. A communication system comprising a plurality of communication devices including first, second and third communication devices and performable of one-on-one communication with one another, the first communication device including:
a search request reception part receiving a search request for data from the second communication device;
a determination part determining whether or not data relevant to the search request is retained;
a search request transmission part transmitting, when the relevant data is not retained, the search request to the third communication device;
a search response reception part receiving, from the third communication device, a search response providing notification that the data relevant to the search request is retained;
a search response transmission part transmitting, to the second communication device that has transmitted the search request, the search response received by the search response reception part, the first communication device relaying the search request, the search response and the data from/to the second communication device and the third communication device;
a notification determination part determining whether or not information concerning data pertaining to the search response received by the search response reception part should be notified; and
an information notification part providing notification of the information when the notification determination part has determined that the information should be notified,
wherein the first communication device that has relayed the search response relays the information from/to the second communication device and the third communication device.

6. A communication device performable of one-on-one communication with one device and another device, comprising:
a search request reception part receiving a search request for data from the one device;
a determination part determining whether or not data relevant to the search request is retained;
a search request transmission part transmitting the search request to another device when the relevant data is not retained;
a data reception part receiving the data relevant to the search request from another device;
a data transmission part transmitting, to the one device that has transmitted the search request, the data received by the data reception part;
a storage determination part determining whether or not the data received by the data reception part should be stored;
a data storage storing the data determined to be stored by the storage determination part;
a notification determination part determining whether or not information concerning the data stored in the data storage should be notified; and
an information notification part providing notification of the information when the notification determination part has determined that the information should be notified.

7. A communication device performable of one-on-one communication with one device and another device, comprising:
a search request reception part receiving a search request for data from the one device;
a determination part determining whether or not data relevant to the search request is retained;
a search request transmission part transmitting the search request to another device when the relevant data is not retained;
a search response reception part receiving, from another device, a search response providing notification that the data relevant to the search request is retained;
a search response transmission part transmitting, to the one device that has transmitted the search request, the search response received by the search response reception part;
a notification determination part determining whether or not information concerning data pertaining to the search response received by the search response reception part should be notified; and
an information notification part providing notification of the information when the notification determination part has determined that the information should be notified.

8. A computer-readable recording medium which stores a computer-executable program for causing a communication device performable of one-on-one communication with each of a plurality of devices to: receive a search request for data from one device; determine whether or not data relevant to the search request is retained; transmit the search request to another device when the relevant data is not retained; receive the data relevant to the search request from another device; and transmit the received data to the one device that has transmitted the search request,
wherein the program causes the communication device to:
determine whether or not the received data should be stored;
store the data determined to be stored;
determine whether or not information concerning the stored data should be notified; and
provide notification of the information when the information is determined to be notified.

9. A computer-readable recording medium which stores a computer-executable program for causing a communication device performable of one-on-one communication with each of a plurality of devices to: receive a search request for data from one device; determine whether or not data relevant to the search request is retained; transmit the search request to another device when the relevant data is not retained; receive, from another device, a search response providing notification that the data relevant to the search request is retained; and transmit the received search response to the one device that has transmitted the search request,
wherein the program causes the communication device to:
determine whether or not information concerning data pertaining to the received search response should be notified; and
provide notification of the information when the information is determined to be notified.
